(19) United States
(12) Patent Application Publication
(10) Pub. No.: US 2016/0186577 A1
(43) Pub. Date: Jun. 30, 2016

(54) COOLING CONFIGURATIONS FOR TURBINE BLADES

(71) Applicant: General Electric Company, Schenectady, NY (US)

(72) Inventor: Fred Thomas Willett, JR., Burnt Hills, NY (US)

(21) Appl. No.: 14/585,854

(22) Filed: Dec. 30, 2014

(51) Int. Cl. F01D 5/18; F01D 9/04; F01D 25/12; F01D 5/14

(52) U.S. Cl. CPC F01D 5/187; F01D 5/147; F01D 9/041; F01D 25/12; F05D 2220/32; F05D 2260/202; F05D 2240/301; F05D 2240/12

(57) ABSTRACT

A blade in a turbine of a gas turbine engine that includes: an outer surface bending along an edge at an angle greater than about 120° so to define a first outer surface to a first side of the edge and a second outer surface to a second side of the edge; an internal flow passage; and a forked cooling channel configured so to fluidly connect the internal flow passage to a first film cooling port and a second film cooling port formed to each side of the edge.

### BACKGROUND OF THE INVENTION

The present application relates generally to apparatus and assemblies concerning the design and operation of blades in the turbines of gas turbine engines. More specifically, but not by way of limitation, the present application relates to configurations of internal cooling channels and film cooling ports within turbine blades.

It will be appreciated that gas turbine engines generally include a compressor, combustor, and turbine. The compressor and turbine sections generally include rows of blades that are axially stacked in stages. Each stage includes a row of circumferentially-spaced stator blades, which are fixed, and a row of rotor blades, which rotate about a central turbine axis or shaft. In operation, generally, the compressor rotor blades rotate about the shaft, and, acting in concert with the stator blades, compress a flow of air. The supply of compressed air then is used in the combustor to combust a supply of fuel. The resulting flow of hot expanding gases from the combustion, i.e., the working fluid, is expanded through the turbine section of the engine. The flow of working fluid through the turbine induces the rotor blades to rotate. The rotor blades are connected to a central shaft such that the rotation of the rotor blades rotates the shaft. In this manner, the energy contained in the fuel is converted into the mechanical energy of the rotating shaft, which, for example, may be used to rotate the rotor blades of the compressor, such that the supply of compressed air needed for combustion is produced, and the coils of a generator, such that electrical power is generated. During operation, because of the extreme temperatures of the hot-gas path, the velocity of the working fluid, and the rotational velocity of the engine, turbine blades, which, as described, generally include both the rotating rotor blades and the fixed, circumferentially-spaced stator blades, become highly stressed with extreme mechanical and thermal loads.

The ever-increasing demand for energy makes the engineering of more efficient gas turbine engines an ongoing and significant objective. While several strategies for increasing the efficiency of turbine engines are known, it remains a challenging objective because these alternatives, which, for example, include increasing the size of the engine, increasing the temperatures through the hot-gas path, and increasing the rotational velocities of the rotor blades, generally place additional strain on parts that are already highly stressed, for example, turbine rotor and stator blades. As a result, improved apparatus, methods and/or systems that reduce operational stresses placed on turbine blades or allow the turbine blades to better withstand these stresses are in great demand. As one of ordinary skill in the art will appreciate, one strategy for alleviating the thermal stress on the blades is through cooling them during operation. Effective cooling, for example, may allow the blades to withstand higher firing temperatures, withstand greater mechanical stresses at high operating temperatures, and/or extend the part-life of the blades, all of which may allow the turbine engine to be more cost-effective and efficient in its operation. One way to cool blades during operation is through the use of internal flow passages. Generally, this involves passing a relatively cool supply of compressed air, which may be supplied by the compressor of the turbine engine, through internal cooling channels or flow passages within the blades. As the compressed air passes through the blade, it convectively cools the blade, which allows the part to withstand firing temperatures that it otherwise could not. If the air is released properly, it may further aid the cooling of the blade through what is referred to film cooling.

For a number of reasons, it will be appreciated that great care is required in designing and manufacturing the configuration of these internal flow passages. First, the use of cooling air comes at a price. That is, air that is diverted from the compressor to the turbine section of the engine for cooling bypasses the combustor and, thus, decreases the efficiency of the engine. As such, internal cooling configurations must be designed to use air in a highly effective manner, i.e., provide the necessary coverage and cooling efficiency, so that a minimum amount of air is needed for this purpose. Second, newer, more aggressively shaped aerodynamic blade configurations are thinner and more curved or twisted, which often rules out the usage of linear flow passages, while the thinness of the blades requires internal cooling passages to perform well while having a compact design. Third, to reduce mechanical loads, internal flow passages may be formed to remove unnecessary weight from the blade; however, the blades still must remain strong to withstand the extreme mechanical loads. Internal flow passages, therefore, must be designed such that the turbine blade has a lightweight but strong construction, while stress concentrations that would negatively affect the blades resilience are avoided. As such, turbine blade cooling configurations that perform well in more aggressively shaped, thinner aerodynamic blade configurations, promote lighter blade internal construction, maintain the structural support of the component, while also delivering high cooling efficiencies would be in commercial demand.

### BRIEF DESCRIPTION OF THE INVENTION

The present application thus describes a blade in a turbine of a gas turbine engine that includes: an outer surface bending along an edge at an angle greater than about 120° so to define a first outer surface to a first side of the edge and a second outer surface to a second side of the edge; an internal flow passage; and a forked cooling channel configured so to fluidly connect the internal flow passage to a first film cooling port and a second film cooling port formed to each side of the edge.

These and other features of the present application will become apparent upon review of the following detailed description of the preferred embodiments when taken in conjunction with the drawings and the appended claims.

### BRIEF DESCRIPTION OF THE DRAWINGS

These and other features of this invention will be more completely understood and appreciated by careful study of the following more detailed description of exemplary embodiments of the invention taken in conjunction with the accompanying drawings, in which:

FIG. 1 is a schematic representation of an exemplary turbine engine in which blades according to embodiments of the present application may be used;

FIG. 2 is a sectional view of the compressor section of the combustion turbine engine of FIG. 1;

FIG. 3 is a sectional view of the turbine section of the combustion turbine engine of FIG. 1;

FIG. 4 is a perspective view of an exemplary turbine rotor blade in which embodiments of the present invention may be used;

FIG. 5 is a sectional top view of a turbine rotor blade having film cooling ports of a conventional design;

FIG. 6 is a sectional top view of a turbine rotor blade having a cooling configuration according to an exemplary embodiment of the present invention;

FIG. 7 is a perspective view of a leading edge of a turbine rotor blade having a cooling configuration according to an exemplary embodiment of the present pension; and

FIG. 8 is a perspective view of a core for casting turbine blades having cooling configurations according to an exemplary embodiment of the present invention.

### DETAILED DESCRIPTION OF THE INVENTION

Aspects and advantages of the invention are set forth below in the following description, or may be obvious from the description, or may be learned through practice of the invention. Reference will now be made in detail to present embodiments of the invention, one or more examples of which are illustrated in the accompanying drawings. The detailed description uses numerical designations to refer to features in the drawings. Like or similar designations in the drawings and description may be used to refer to like or similar parts of embodiments of the invention. As will be appreciated, each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents. It is to be understood that the ranges and limits mentioned herein include all sub-ranges located within the prescribed limits, inclusive of the limits themselves unless otherwise stated. Additionally, certain terms have been selected to describe the present invention and its component subsystems and parts. To the extent possible, these terms have been chosen based on the terminology common to the technology field. Still, it will be appreciated that such terms often are subject to differing interpretations. For example, what may be referred to herein as a single component, may be referenced elsewhere as consisting of multiple components, or, what may be referenced herein as including multiple components, may be referred to elsewhere as being a single component. In understanding the scope of the present invention, attention should not only be paid to the particular terminology used, but also to the accompanying description and context, as well as the structure, configuration, function, and/or usage of the component being referenced and described, including the manner in which the term relates to the several figures, as well as, of course, the precise usage of the terminology in the appended claims. Further, while the following examples are presented in relation to a certain type of turbine engine, the technology of the present invention also may be applicable to other types of turbine engines as would the understood by a person of ordinary skill in the relevant technological arts.

Given the nature of turbine engine operation, several descriptive terms may be used throughout this application so to explain the functioning of the engine and/or the several sub-systems or components included therewithin, and it may prove beneficial to define these terms at the onset of this section. Accordingly, these terms and their definitions, unless stated otherwise, are as follows. The terms “forward” and “aft”, without further specificity, refer to directions relative to the orientation of the gas turbine. That is, “forward” refers to the forward or compressor end of the engine, and “aft” refers to the aft or turbine end of the engine. It will be appreciated that each of these terms may be used to indicate movement or relative position within the engine. The terms “downstream” and “upstream” are used to indicate position within a specified conduit relative to the general direction of flow moving through it. (It will be appreciated that these terms reference a direction relative to an expected flow during normal operation, which should be plainly apparent to anyone of ordinary skill in the art.) The term “downstream” refers to the direction in which the fluid is flowing through the specified conduit, while “upstream” refers to the direction opposite that. Thus, for example, the primary flow of working fluid through a turbine engine, which beings as air moving through the compressor and then becomes combustion gases within the combustor and beyond, may be described as beginning at an upstream location toward an upstream or forward end of the compressor and terminating at an downstream location toward a downstream or aft end of the turbine. In regard to describing the direction of flow within a common type of combustor, as discussed in more detail below, it will be appreciated that compressor discharge air typically enters the combustor through impingement ports that are concentrated toward the aft end of the combustor (relative to the combustors longitudinal axis and the aforementioned compressor/turbine positioning defining forward/aft distinctions). Once in the combustor, the compressed air is guided by a flow annulus formed about an interior chamber toward the forward end of the combustor, where the air flow enters the interior chamber and, reversing it direction of flow, travels toward the aft end of the combustor. In yet another context, coolant flows through internal flow passages may be treated in the same manner.

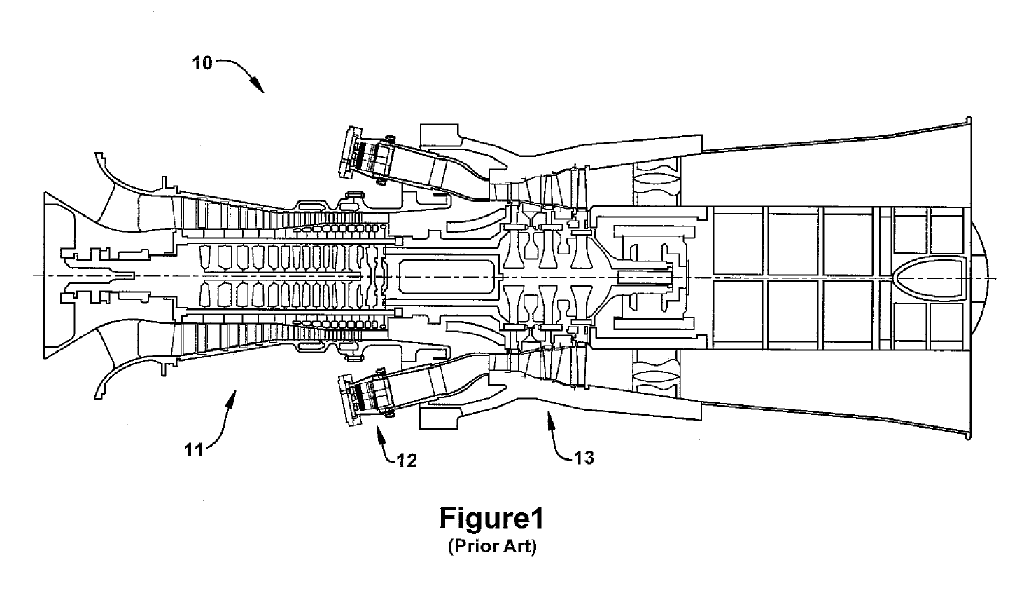

Additionally, given the configuration of compressor and turbine about a central common axis, as well as the cylindrical configuration common to many combustor types, terms describing position relative to an axis may be used herein. In this regard, it will be appreciated that the term “radial” refers to movement or position perpendicular to an axis. Related to this, it may be required to describe relative distance from the central axis. In this case, for example, if a first component resides closer to the central axis than a second component, the first component will be described as being either “radially inward” or “inboard” of the second component. If, on the other hand, the first component resides further from the central axis than the second component, the first component will be described herein as being either “radially outward” or “outboard” of the second component. Additionally, as will be appreciated, the term “axial” refers to movement or position parallel to an axis. Finally, the term “circumferential” refers to movement or position around an axis. As mentioned, while these terms may be applied in relation to the common central axis that extends through the compressor and turbine sections of the engine, these terms also may be used in relation to other components or sub-systems of the engine. By way of background, referring now to the figures, FIGS. 1 through 3 illustrate an exemplary combustion turbine engine in which embodiments of the present application may be used. It will be understood by those skilled in the art that the present invention is not limited to this type of usage. As stated, the present invention may be used in combustion turbine engines, such as the engines used in power generation and airplanes, steam turbine engines, and other types of rotary engines. The examples provided are not meant to be limiting to the type of the turbine engine.

FIG. 1 is a schematic representation of a combustion turbine engine 10. In general, combustion turbine engines operate by extracting energy from a pressurized flow of hot gas produced by the combustion of a fuel in a stream of compressed air. As illustrated in FIG. 1, combustion turbine engine 10 may be configured with an axial compressor 11 that is mechanically coupled by a common shaft or rotor to a downstream turbine section or turbine 13, and a combustor 12 positioned between the compressor 11 and the turbine 13.

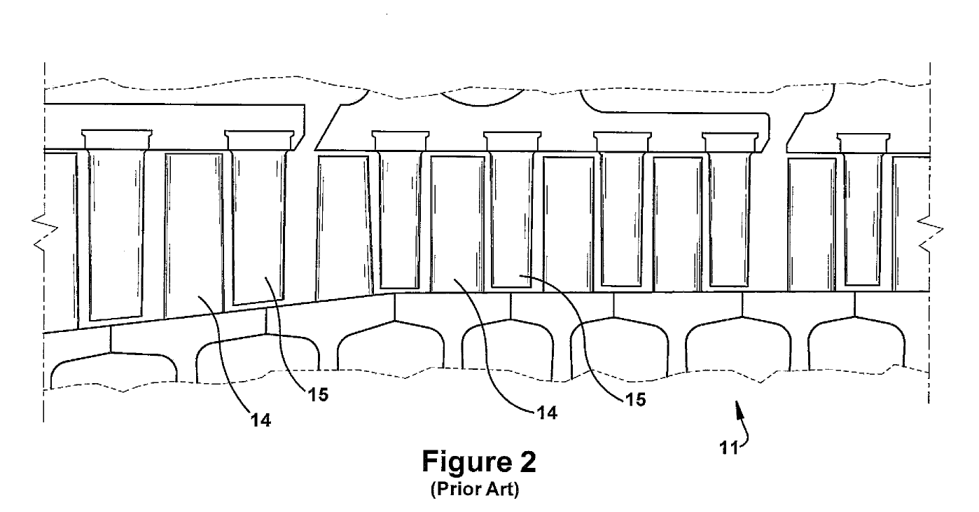

FIG. 2 illustrates a view of an exemplary multi-staged axial compressor 11 that may be used in the combustion turbine engine of FIG. 1. As shown, the compressor 11 may include a plurality of stages. Each stage may include a row of compressor rotor blades 14 followed by a row of compressor stator blades 15. Thus, a first stage may include a row of compressor rotor blades 14, which rotate about a central shaft, followed by a row of compressor stator blades 15, which remain stationary during operation.

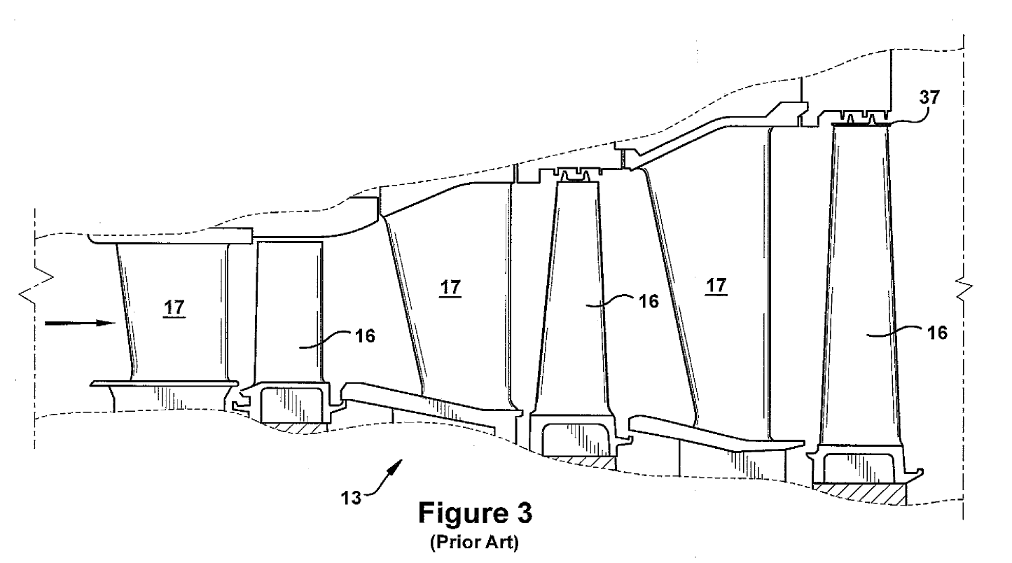

FIG. 3 illustrates a partial view of an exemplary turbine section or turbine 13 that may be used in the combustion turbine engine of FIG. 1. The turbine 13 may include a plurality of stages. Three exemplary stages are illustrated, but more or less stages may be present in the turbine 13. A first stage includes a plurality of turbine buckets or turbine rotor blades 16, which rotate about the shaft during operation, and a plurality of nozzles or turbine stator blades 17, which remain stationary during operation. The turbine stator blades 17 generally are circumferentially spaced one from the other and fixed about the axis of rotation. The turbine rotor blades 16 may be mounted on a turbine wheel (not shown) for rotation about the shaft (not shown). A second stage of the turbine 13 also is illustrated. The second stage similarly includes a plurality of circumferentially spaced turbine stator blades 17 followed by a plurality of circumferentially spaced turbine rotor blades 16, which are also mounted on a turbine wheel for rotation. A third stage also is illustrated, and similarly includes a plurality of turbine stator blades 17 and rotor blades 16. It will be appreciated that the turbine stator blades 17 and turbine rotor blades 16 lie in the hot gas path of the turbine 13. The direction of flow of the hot gases through the hot gas path is indicated by the arrow. As one of ordinary skill in the art will appreciate, the turbine 13 may have more, or in some cases less, stages than those that are illustrated in FIG. 3. Each additional stage may include a row of turbine stator blades 17 followed by a row of turbine rotor blades 16.

In one example of operation, the rotation of compressor rotor blades 14 within the axial compressor 11 may compress a flow of air. In the combustor 12, energy may be released when the compressed air is mixed with a fuel and ignited. The resulting flow of hot gases from the combustor 12, which may be referred to as the working fluid, is then directed over the turbine rotor blades 16, the flow of working fluid inducing the rotation of the turbine rotor blades 16 about the shaft. Thereby, the energy of the flow of working fluid is transformed into the mechanical energy of the rotating blades and, because of the connection between the rotor blades and the shaft, the rotating shaft. The mechanical energy of the shaft may then be used to drive the rotation of the compressor rotor blades 14, such that the necessary supply of compressed air is produced, and also, for example, a generator to produce electricity.

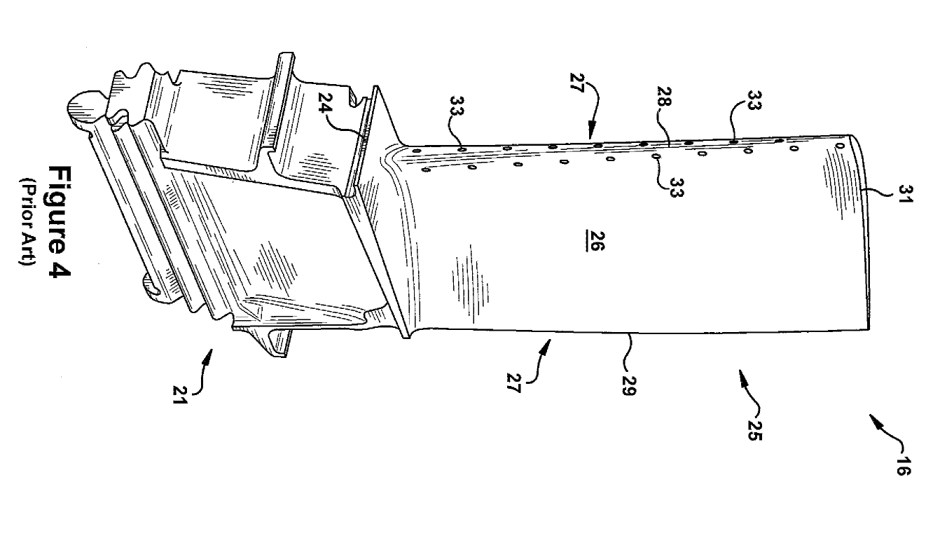

FIG. 4 is a perspective view of a turbine rotor blade 16 of the type in which embodiments of the present invention may be employed. The turbine rotor blade 16 includes a root 21 by which the rotor blade 16 attaches to a rotor disc. The root 21 may include a dovetail configured for mounting in a corresponding dovetail slot in the perimeter of the rotor disc. The root 21 may further include a shank that extends between the dovetail and a platform 24, which is disposed at the junction of the airfoil 25 and the root 21 and defines a portion of the inboard boundary of the flow path through the turbine 13. It will be appreciated that the airfoil 25 is the active component of the rotor blade 16 that intercepts the flow of working fluid and induces the rotor disc to rotate. While the blade of this example is a turbine rotor blade 16, it will be appreciated that the present invention also may be applied to other types of blades within the turbine engine 10, including turbine stator blades 17. It will be seen that the airfoil 25 of the rotor blade 16 includes a concave pressure side face 26 and a circumferentially or laterally opposite convex suction side face 27 extending axially between opposite leading and trailing edges 28, 29 respectively. The side faces 26 and 27 also extend in the radial direction from the platform 24 to an outboard tip 31. As also illustrated in FIG. 4, film cooling ports 33 may be formed through the outer surface of the rotor blade 16 for the release of coolant that is circulated through internal cooling circuits or passages.

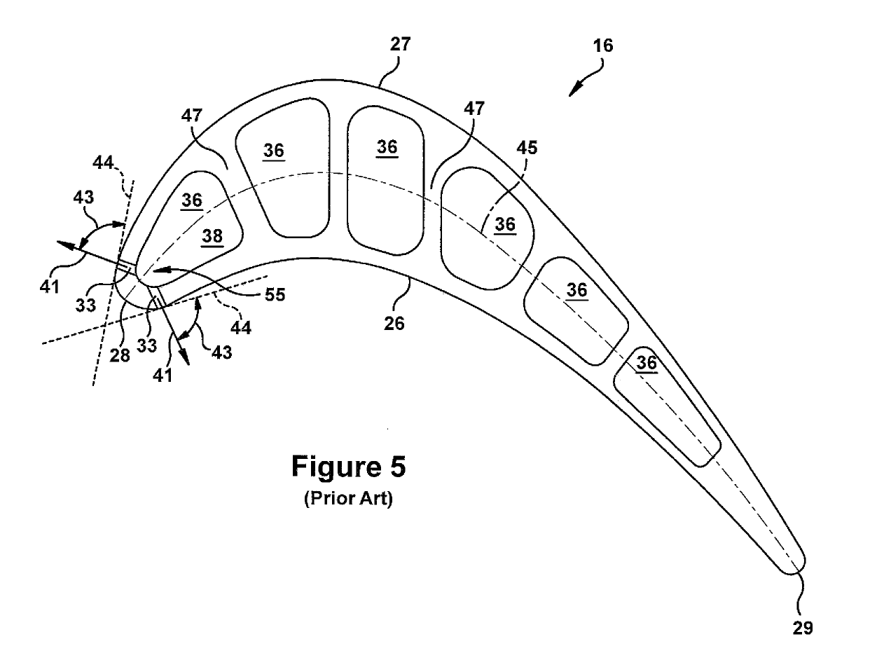

FIG. 5 provides a top sectional view of interior internal flow passages 36 and/or film cooling ports 33 according to a configuration of conventional design. Though other internal configurations are possible, as illustrated, a number of internal flow passages 36 may be defined within the airfoil 25. The internal flow passages 36 may comprise a serpentine arrangement through which air is forced in alternating directions for cooling the rotor blade 16. The airfoil may include an outer wall defined between the outer surface of the pressure side and suction side faces and an inner surface that resides in approximate spaced relation thereto pursuant to a substantially constant wall thickness. A leading edge flow passage 38 may reside adjacent to the leading edge 28 of the airfoil. The leading edge flow passage 38 may include a rounded corner extending radially in approximate spaced relation to the leading edge 28 of the airfoil 25. As will be appreciated, certain areas of the airfoil 25 present challenging criteria for designing cooling configurations that are cost-effective to manufacture while also providing the necessary cooling in an efficient manner. These areas include regions of high curvature, such as the leading edge 28 of the airfoil 25, because of the difficulties in making efficient use of coolant. That is, coolant may be most efficiently used by circulating it through the internal flow passages 36 near the outer surface of the airfoil 25 and then discharging it a way that takes full advantage of its film cooling properties. To do the latter, film cooling ports perform better when the coolant is discharged in a direction that is parallel or at least at a shallow acute angle relative to the surface contour of the airfoil that surrounds the film cooling ports. More specifically, by following the airfoil contour as closely as possible and how the coolant is discharged produces better film cooling results. However, as is illustrated in FIG. 5, the leading edge region of the airfoil is a narrow space which typically is further reduced in size by the need to configure a leading edge flow passage 38 that extends radially and in close proximity to the leading edge 28 of the airfoil 25. As will be appreciated, in order to position film cooling ports 33 near the leading edge 28, the direction of discharge 41 comprises a steep tangent or discharge angle 43 relative to the surface contour 44 of the airfoil 25 defined about the film cooling port 33. The steep discharge angle negatively impacts the film cooling efficiency around the leading edge of the airfoil. Configurations that push the linearly configured film cooling ports 33 nearer to the leading edge 28 just result in steepening the tangent angle. Whereas, those configurations that allow for shallower tangent angles may perform better with regard to the downstream surfaces of the airfoil, but, as will be appreciated, result in film cooling ports 33 that are positioned too distant from the leading edge 28 to provide any cooling thereto. Another approach is to drill cooling holes in a direction that is essentially radial, or at a shallow angle to the radial direction. This may be used to create a release point on the leading edge, but, as will be appreciated, the film cooling is ineffective because the coolant release is discharged perpendicular to the main airflow and, thus, does not adhere to or lay down well on the surface of the airfoil. These consideration have led to designs that include axially oriented, but steep discharge angles relative the airfoil surface contour, or film holes at a shallow angles relative the surface contour, but are released in a substantially radial direction and, thus, perpendicular to the main flow.

As also shown, the leading edge flow passage 38 may be enclosed by an internal rib 47 that encloses the corner 55 formed by the inner surfaces of the walls forming the leading edge 28 of the airfoil 25. The rib 47 may extend across the internal cavity of the airfoil 25 to create axially stacked flow passages. The ribs 47 may extend across the camber line 45 of the airfoil 25 so to connect the inner surface of the pressure side face 26 to the inner surface of the suction side face 27.

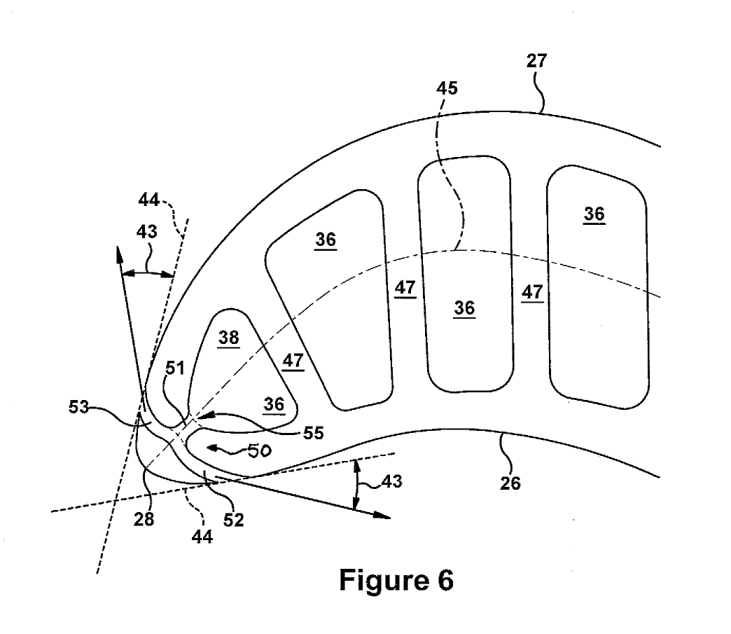

Turning to FIGS. 6 through 8, several exemplary embodiments of the present invention are illustrated. Those of ordinary skill in the art will appreciate that the present invention is not limited to only these specific configurations and may be applied as broadly as the appended claims allow. FIG. 6 is a sectional top view of a turbine rotor blade 16 having internal flow passages and/or film cooling ports according to the present invention. According to preferred embodiments, a bifurcated or forked cooling channel 50 is provided along an area of high curvature, such as the leading edge 28 of the airfoil 25. The present invention may further be applied to other regions of the airfoil 25 that have similar configurations. As will be discussed, the forked cooling channel 50 may be configured so to fluidly connect an internal flow passage 36 to film cooling ports formed through the outer surfaces defined to each side of a highly bent and/or rounded edge, such as is common at the leading edges of airfoils of many types of turbine rotor blades. To achieve this, for example, the forked cooling channel 50 may bifurcate into cooling channels that carry coolant to the surfaces formed to each side of the leading edge. As will be appreciated, given the novel configurations discussed therein, the film cooling ports 33 to each side of the edge may be configured to discharge coolant in a downstream direction (i.e., with the flow and mostly axial relative to the turbine) and at a relatively shallow angle in relation to the contour of the outer surfaces of the airfoil 25. This result will improve the film cooling achieved by the flow of coolant.

According to the present invention, the forked cooling channel may include an upstream section 51 and a downstream section. The upstream section 51 is defined between an inlet formed at the leading edge flow passage 33 and a bifurcation point, i.e., where the upstream section 51 forks into the downstream section. The downstream section may include a pressure side fork 52 that extends between the bifurcation point and a pressure side film cooling port 33 formed through the pressure side face 26 of the airfoil 25. The downstream section may further include a suction side fork 53 that extends between the bifurcation point and a suction side film cooling port 33 formed through the suction side face 27 of the airfoil 25. According to certain embodiments, the upstream section 51 is configured so to extend along an axis approximately defined by the airfoil camber line 45. Further, the inlet, as shown, may be positioned at the corner 55 of the leading edge flow passage 38. The bifurcation point may be configured so to occur approximately midway between the wall thickness of the outer wall of the airfoil 25.

The pressure side 52 and suction side fork 53 may be curved along a longitudinal axis. The pressure side fork 52 may have a smooth curved profile in accordance with the curvature between a first direction defined by a discharge direction of the upstream section 51 of the forked cooling channel 50 (at the bifurcation point) and a second direction defined by the desired discharge direction necessary for achieving a shallow discharge angle at the pressure side film cooling port 33. Likewise, the suction side fork 53 may have a smooth curved profile in accordance with the curvature between the discharge direction of the upstream section 51 of the forked cooling channel 50 and a second direction defined by the desired discharge direction necessary for achieving a shallow discharge angle at the suction side film cooling port 33. As will be appreciated, what constitutes a desirable shallow discharge angle 43 may vary depending on several criteria. According to certain embodiments, the shallow discharge angle is one that is less than about 45°. According to other embodiments, the shallow discharge angle is less than about 30°. More preferably, the shallow discharge angle is less than about 15°. The shape of the pressure side fork 53 and the suction side fork 53 may each include a tapered profile.

The pressure side 52 and suction side forks 53 may be configured as having a circular cross-sectional shape that remains substantially constant over the longitudinal axis of the channels. Other profiles are also possible, such as a flared or tapered profile. The pressure side 52 and suction side fork 53 also may be configured with metered cross-sectional profiles. In this case, the cross-sectional profiles of each are configured according to disparate levels of coolant flow intended for each side of the airfoil 25 during operation. The pressure side film cooling port 33 and the suction side film cooling port 33 may each have an oval shape given the oblique angle at which the pressure side 52 and suction side forks 53 encounter the respective faces of the airfoil 25.

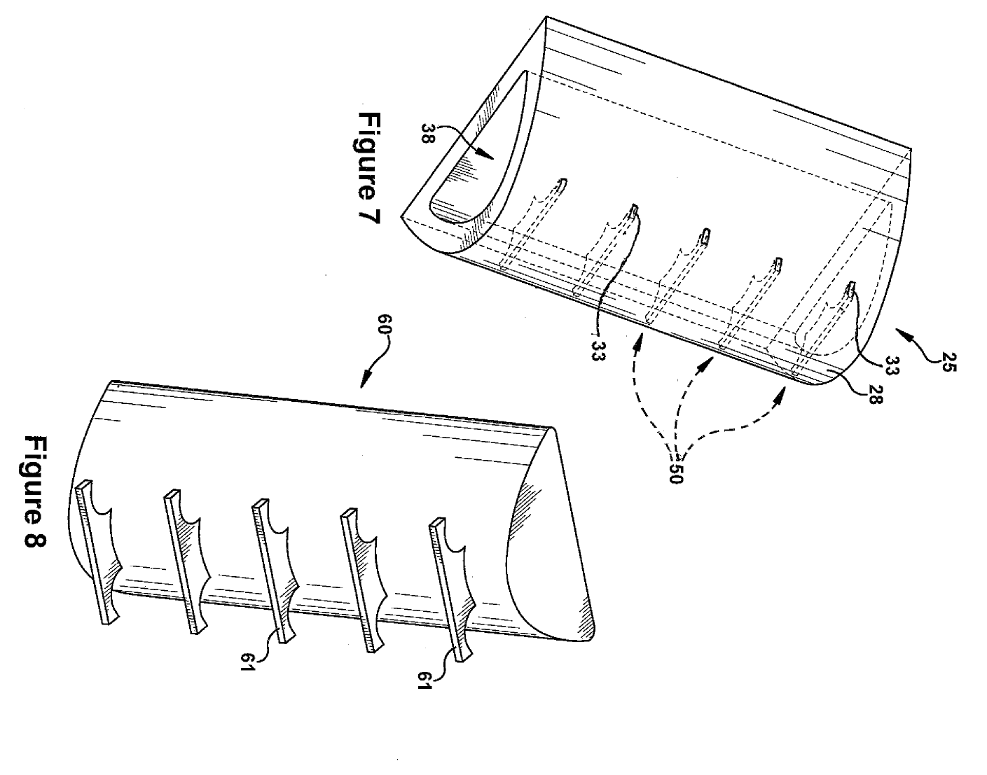

FIG. 7 is a perspective view of an airfoil 25 that includes a cooling configuration according the present invention. As shown, according to preferred embodiments, multiple forked cooling channels 50, for example, between 10 and 30, may be radially spaced at regular intervals along the leading edge of the airfoil 25. The forked cooling channel 50 may be arranged so that the film cooling ports 33 comprises an approximate same radial height on the airfoil 25.

FIG. 8 illustrates an exemplary leading edge core 60 that may be used in a casting process to manufacture blades having internal cooling configurations discussed above, such as the configuration of FIG. 7. As will be appreciated, film cooling ports are traditionally drilled, which, as discussed, limits how they may be used, particularly in locations like the leading edge of the airfoil. Such drilling operations place limitations on the shape and location of the ports, as well as the discharge angles that may be achieved. One reason for this is that the line-of-sight needed for cost-effective drilling operations. Traditionally, cast-in film cooling holes have not been feasible because the conventional core-making process requires core die pull planes so that cores can be removed from the die for use in the casting. As will be appreciated, this limits the design to film cooling ports that are parallel to the pull plane. The core 60 of FIG. 8 is not limited in this way because it is created via an additive manufacturing process that, according to the present invention, may be used to make cast-in film cooling ports more cost-effective. The film cooling ports may be cast into the blade via the core-ports 61 that are produced on the core 60 by the additive manufacturing process.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, all of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A blade for a turbine of a gas turbine engine, the blade comprising:
an outer surface sharply bending along an edge so to define on each side of the edge a first outer surface and a second outer surface;
an internal flow passage; and
a forked cooling channel configured so to fluidly connect the internal flow passage to a first film cooling port formed through the first outer surface and a second film cooling port formed through the second outer surface;
wherein the first film cooling port and the second film cooling port each comprises a shallow discharge angle.

2. The blade according to claim 1, wherein blade comprises one of a rotor blade and a stator blade, and the outer surface comprises an airfoil;
wherein the sharp bend of the outer surface along the edge comprises an angle greater than about 120° and wherein the edge comprises a rounded surface contour;
wherein the discharge angle of the first film cooling port is defined by an angle between a direction of discharge of the first film cooling port and a downstream surface contour adjacent to the first film cooling port;
wherein the discharge angle of the second film cooling port is defined by an angle between a direction of discharge of the second film cooling port and a downstream surface contour adjacent to the second film cooling port; and
wherein the shallow discharge angle comprises an angle less than about 45°.

3. The blade according to claim 1, wherein the blade comprises a rotor blade and the outer surface comprises an airfoil of the rotor blade;
wherein the edge comprises a leading edge of the airfoil such that the first outer surface comprises a pressure side face and the second outer surface comprises a suction side face;
wherein the shallow discharge angle comprise a discharge angle less than about 45°; and
wherein the forked cooling channel comprises a substantially constant radial height.

4. The blade according to claim 3, wherein the airfoil comprises an outer wall defined between the outer surface and an inner surface that resides in approximate spaced relation thereto pursuant to a substantially constant wall thickness, and wherein the inner surface defines the internal flow passage.

5. The blade according to claim 4, wherein the internal flow passage comprises a radially extending leading edge flow passage that is configured to fluidly communicate with a coolant source; and
wherein the leading edge flow passage comprises a radially extending corner resided in approximate spaced relation to the leading edge of the airfoil, the leading edge flow passage being further bounded by an internal rib that encloses the corner by extending between the inner surface of the pressure side face and the inner surface of the suction side face.

6. The blade according to claim 5, wherein the edge comprises a rounded surface contour, and wherein the sharp bend of the edge comprises an angle greater than about 135°.

7. The blade according to claim 6, wherein the corner comprises a rounded surface contour, and wherein the inner surface of the pressure side face and the inner surface of the suction side face comprise a corner angle of less than about 45°.

8. The blade according to claim 6, wherein the forked cooling channel comprises an inlet for fluidly communicating with the leading edge flow passage; and
wherein the first film cooling port comprises a pressure side film cooling port formed through the pressure side face of the airfoil, and the second film cooling port comprises a suction side film cooling port formed through the suction side face of the airfoil.

9. The blade according to claim 8, wherein the inlet of the forked cooling channel is positioned on the corner of the leading edge flow passage.

10. The blade according to claim 8, wherein the forked cooling channel comprises an upstream section defined between the inlet and a bifurcation point where the upstream section connects to a downstream section; and
wherein the downstream section includes: a pressure side fork that extends between the bifurcation point and the pressure side film cooling port; and a suction side fork that extends between the bifurcation point and the suction side film cooling port.

11. The blade according to claim 10, wherein the upstream section of the forked cooling channels is configured so to extend along an axis approximately defined by a camber line of the airfoil.

12. The blade according to claim 10, wherein the bifurcation point comprises a position approximately midway between the wall thickness of the outer wall of the airfoil.

13. The blade according to claim 10, further comprising a plurality of the forked cooling channels positioned at radially spaced intervals along the leading edge of the airfoil;
wherein the pressure side film cooling ports and the suction side film cooling ports for each of the forked cooling channels are positioned at approximately a same radial height on the airfoil.

14. The blade according to claim 13, wherein the plurality of the forked cooling channels comprise between about 10 and 30.

15. The blade according to claim 10, wherein the pressure side fork and the suction side fork each comprise a tapered profile.

16. The blade according to claim 10, wherein the pressure side fork and the suction side fork each comprise a flared profile.

17. The blade according to claim 10, wherein the pressure side fork and the suction side fork comprise a metered cross-sectional profile, the metered cross-sectional profile configured according to disparate levels of coolant flow intended for each of the pressure side face and the suction side face of the airfoil during operation.

18. The blade according to claim 10, wherein along a longitudinal axis the pressure side fork comprises a smooth curved profile in accordance with a curvature between a first direction defined by a discharge angle of the upstream section of the forked cooling channel at the bifurcation point and a second direction defined by the discharge angle at the pressure side film cooling port; and
wherein the suction side fork comprises along a longitudinal axis a smooth curved profile in accordance with a curvature between the first direction defined by the discharge angle of the upstream section of the forked cooling channel at the bifurcation point and a second direction defined by the discharge angle at the pressure side film cooling port.

19. The blade according to claim 10, wherein the each of the pressure side film cooling port and the suction side film cooling port comprise an oval shape; and
wherein the shallow discharge angle comprise a discharge angle of less than about 30°.

20. The blade according to claim 2, wherein the discharge direction comprises an axial direction according to the turbine of the gas turbine engine; and
wherein the shallow discharge angle comprise a discharge angle of less than about 15°.
